(19) United States
(12) Patent Application Publication
(10) Pub. No.: US 2006/0181641 A1
(43) Pub. Date: Aug. 17, 2006

(54) Apparatus and method for outputting on-screen display of display apparatus

(75) Inventor: Hyuk-Jin Ko, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/353,389

(22) Filed: Feb. 14, 2006

(30) Foreign Application Priority Data
Feb. 11, 2005 (KR) 2005-11559

(51) Int. Cl. H04N 9/74; H04N 7/01

(52) U.S. Cl. 348/445; 348/581

(57) ABSTRACT

Provided are an apparatus and a method for outputting an OSD (On-Screen Display) of a display apparatus. The apparatus includes a counter, an OSD controller, and a first storage unit. The counter counts the number of pixels of an OSD window. The OSD controller generates an OSD data request address signal for requesting OSD data and a read address signal for outputting OSD data to be displayed, in response to a counting bit. The first storage unit outputs stored OSD data to the display apparatus in response to the read address signal. In an apparatus and a method for outputting an OSD of a display apparatus, it is possible to reduce the time required to read and transmit OSD data when OSD windows overlap.

### CROSS-REFERENCE TO RELATED PATENT APPLICATIONS

This application claims priority to Korean Patent Application No. 10-2005-0011559, filed on Feb. 11, 2005, the disclosure of which is herein incorporated by reference in its entirety.

### BACKGROUND OF THE INVENTION

1. Technical Field

The present invention relates to an apparatus and a method for outputting an On-Screen Display of a display apparatus.

2. Description of the Related Art

An OSD (On-Screen Display) occupies a portion of the screen of a display apparatus, for example, displaying information to provide a control interface for the user.

FIG. 1 is a block diagram of a conventional OSD data display apparatus 100. Referring to FIG. 1, the OSD data display apparatus 100 includes a video memory VM, an OSD memory OSD_M, a video temporary storage unit VF, an OSD temporary storage unit OF, and a selector 110.

The video memory VM stores and outputs the input video data VD. The OSD memory OSD_M stores and outputs the input OSD data OSD_D. The video temporary storage unit VF temporarily stores and outputs the video data VD received from the video memory VM. The video temporary storage unit VF may be implemented using a FIFO (First In First Out) data structure.

The OSD temporary storage unit OF temporarily stores and outputs the OSD data OSD_D received from the OSD memory OSD_M. The OSD temporary storage unit OF may be implemented using a FIFO data structure. The selector 110 selectively outputs one of the video data VD or the OSD data OSD_D to a screen, in response to a predetermined control signal CTRL.

FIG. 2 shows a relationship between two OSD windows displayed on a screen and OSD data blocks in memory.

Referring to FIGS. 1 and 2, the OSD windows WD1 and WD2 occupy predetermined regions of a screen 210 on which OSD data OSD_D is displayed. The OSD data OSD_D corresponding to the OSD windows WD1 and WD2, respectively, is stored in areas M1 and M2 of an OSD memory OSD_M.

If the OSD window WD1 or WD2 is activated for a region in which video data VD is being displayed on the screen 210, an OSD controller (not shown) requests the OSD memory OSD_M to transmit corresponding OSD data OSD_D. The OSD data OSD_D transmitted in response to the request from the OSD controller is output via an OSD temporary storage unit OF to the screen 210.

When a circuit accesses the OSD memory OSD_M, page crossing accesses can occur. Transactions that cross a page boundary occur in the case where the OSD data OSD_D output for every predetermined number of words from an OSD memory OSD_M extends from one page to a next page across a page boundary. The transactions that cross a page boundary typically require a larger amount of time to output the requested OSD data.

A conventional method to minimize the occurrence of page crossing accesses involves appropriately varying a start address of OSD data to be read from an OSD memory. However, this method may not resolve the case when two or more OSD windows overlap on a screen.

FIG. 3 shows overlapping OSD windows and OSD memory areas corresponding to the overlapping OSD windows. FIG. 3 shows an area M2 of the OSD memory OSD_M storing OSD data corresponding to the second OSD window WD2.

Referring to FIG. 3, S_ADD represents an address of the OSD data OSD_D corresponding to the first pixel of the second OSD window WD2, which is stored in the OSD memory OSD_M. As shown in FIG. 3, the second OSD window WD2 overlaps the first OSD window WD1. A pixel of the second OSD window WD2 displayed on a screen is denoted by “Y”. An address of the OSD data OSD_D of the OSD memory OSD_M corresponding to the pixel Y shown in FIG. 3 is denoted by “Y_ADD”.

Starting from the address Y_ADD, the OSD data OSD_D corresponding to the second OSD window WD2 to be displayed on a screen is read out from the OSD memory OSD_M. In the case when OSD data OSD_D extending across a page boundary is requested while continuously accessing the OSD memory OSD_M to read OSD data OSD_D, an OSD controller (not shown) processes the request for the OSD data OSD_D as a unit transmission request. However, as described above, additional time is required to read the requested OSD data OSD_D in the cross page access, and the transmission of the OSD data OSD_D to the OSD temporary storage unit OF of FIG. 1 may fail.

FIG. 4 shows a data block corresponding to the address Y_ADD in the memory OSD_M. Referring to FIGS. 1 through 4, the OSD data OSD_D may be read out for every 4 words from the OSD memory OSD_M. A start pixel Y of the second OSD window WD2 corresponds to an address Y_ADD. Each horizontal line of the OSD memory OSD_M corresponds to a single word.

When the OSD data OSD_D is read out for every 4 words from the address S_ADD, in a case where the window is not overlapped, it is possible to minimize the occurrence of page crossing accesses by appropriately varying a start address of OSD data to be read from the OSD memory OSD_M. However, in the case where the window is overlapped, the address from which the OSD data OSD_D is read out is recalculated every one line. In this case, in the conventional OSD data display apparatus 100, during read-out, a page crossing access occurs across the page boundary BD.

### SUMMARY OF THE INVENTION

Exemplary embodiments of the present invention are directed to an apparatus and method for outputting an OSD (On-Screen Display) of a display apparatus.

In an exemplary embodiment of the present invention, an apparatus for outputting an OSD (On-Screen Display) of a display apparatus includes a counter, an OSD controller, and a first storage unit. The counter counts the number of pixels of an OSD window. The OSD controller generates an OSD data request address signal for requesting OSD data and a read address signal for outputting OSD data to be displayed, in response to a counting bit. The first storage unit outputs stored OSD data to the display apparatus in response to the read address signal.

According to an aspect of the present invention, each pixel of the OSD window comprises 2ⁿ bits of OSD data and the OSD data request address signal is a logic value corresponding to a bit value obtained by replacing the lower 7-n bits of the counting bit by 0's, wherein n is a natural number. According to another aspect of the present invention, each pixel of the OSD window comprises 2ⁿ bits of OSD data and the read address signal is a logic value corresponding to the lower 7-n bits of the counting bit, wherein n is a natural number. The first storage unit may use a FIFO (First In First Out) data structure.

In an exemplary embodiment of the present invention, the OSD data display apparatus further includes a second storage unit outputting stored OSD data for every 2^{m} words to the first storage unit in response to the OSD data request address signal, wherein m is a positive integer equal to or greater than 2. According to an aspect of the present invention, second storage unit comprises SDRAM (Synchronous Dynamic Random Access Memory).

In an exemplary embodiment of the present invention, the apparatus for outputting an OSD of a display apparatus further includes a delay unit and a selector. The delay unit delays and outputs video data received from an external source. The selector selectively outputs one of the video data received from the delay unit or the OSD data received from the first storage unit, in response to a control signal. According to an aspect of the present invention, each pixel of the OSD window comprises 16 bits of OSD data, the OSD data request address signal is a logic value corresponding to the remaining bits of the counting bit excluding the lower 3 bits of the counting bit, and the read address signal is a logic value corresponding to the lower 3 bits of the counting bit.

In an exemplary embodiment of the present invention, an apparatus for outputting an OSD of a display apparatus includes an OSD controller, wherein the OSD controller generates an OSD data request address signal for requesting OSD data and a read address signal for outputting OSD data to be displayed, in response to a counting bit; and a storage unit, wherein the storage unit outputs stored OSD data to the display apparatus in response to the read address signal.

In an exemplary embodiment of the present invention, a method of outputting an OSD of a display apparatus includes: counting the number of pixels of an OSD window; generating an OSD data request address signal for requesting the OSD data in response to a counting bit; outputting the OSD data for every 2^{m} words in response to the OSD data request address signal; generating a read address signal for outputting OSD data to be displayed in response to the counting bit; and outputting stored OSD data to the display apparatus in response to the read address signal.

In an exemplary embodiment of the present invention, the method further comprises: delaying and outputting video data received from an external source; determining whether a current mode is a video mode or an OSD mode; and selectively outputting one of the delayed video data or the OSD data according to the determination result. According to an aspect of the present invention, each pixel of the OSD window comprises 16 bits of OSD data, the OSD data request address signal is a logic value corresponding to the remaining bits of the counting bit excluding the lower 3 bits of the counting bit, and the read address signal is a logic value corresponding to the lower 3 bits of the counting bit.

### BRIEF DESCRIPTION OF THE DRAWINGS

The present invention will become more apparent to those of ordinary skill in the art when descriptions of exemplary embodiments thereof are read with reference to the accompanying drawings, of which:

FIG. 1 is a block diagram of a conventional OSD (On-Screen Display) data display apparatus.

FIG. 2 shows a relationship between two OSD windows displayed on a screen and OSD data blocks in memory.

FIG. 3 shows overlapping OSD windows and OSD memory areas corresponding to the overlapping OSD windows.

FIG. 4 shows a data block corresponding to the address Y_ADD in the memory OSD_M.

FIG. 5 is a block diagram of an apparatus for outputting an OSD of a display apparatus according to an exemplary embodiment of the present invention.

FIG. 6 shows a method of reading OSD data from first and second storage units of the OSD data display apparatus of FIG. 5.

FIG. 7 is a flowchart illustrating a method of outputting an OSD of a display apparatus according to an exemplary embodiment of the present invention.

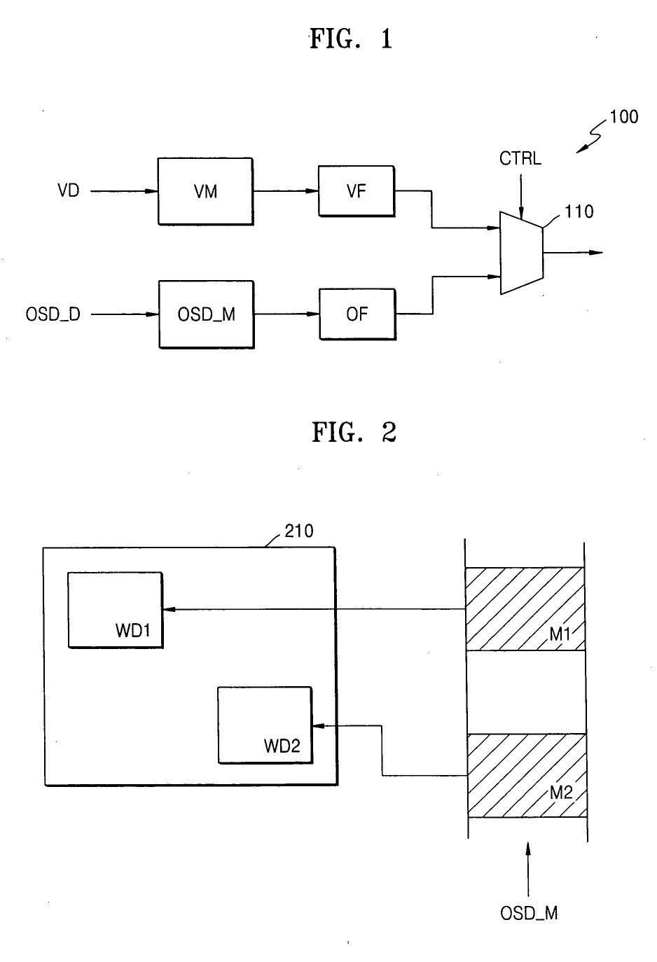

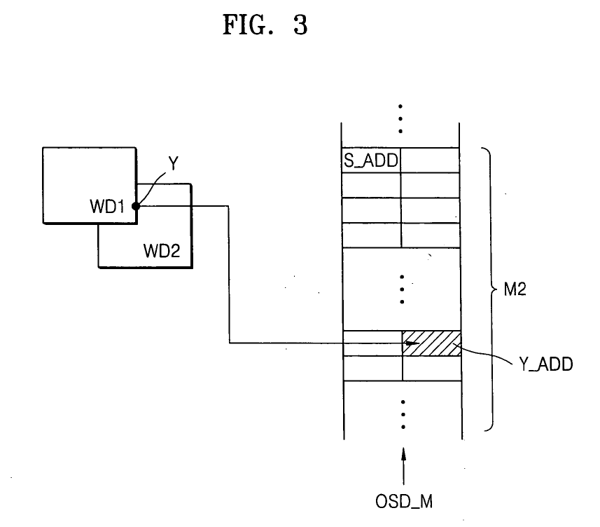

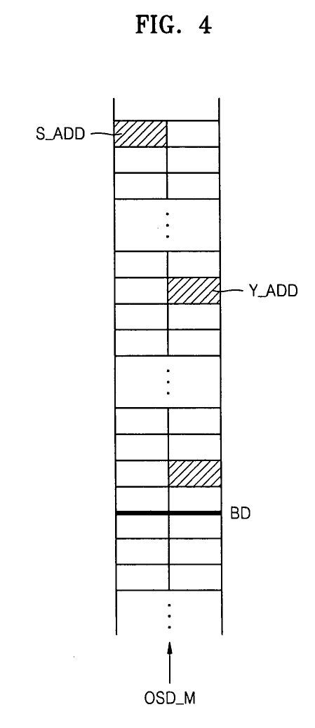

### DETAILED DESCRIPTION OF THE EXEMPLARY EMBODIMENTS

The exemplary embodiments of present invention will now be described in detail with reference to the accompanying drawings. Like reference numerals refer to similar or identical elements throughout the description of the figures. As used herein, “natural numbers” are the numbers 1, 2, 3, . . . .

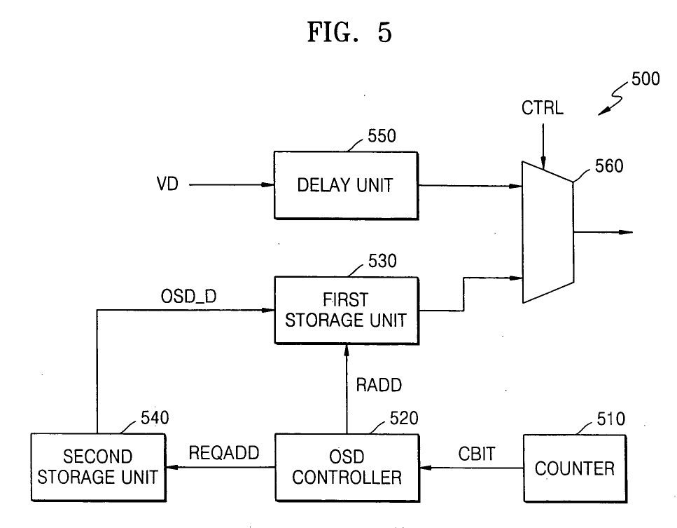

FIG. 5 is a block diagram of an apparatus for outputting an OSD (of a display apparatus 500, according to an exemplary embodiment of the present invention. Referring to FIG. 5, the OSD data display apparatus 500 includes a counter 510, an OSD controller 520, and a first storage unit 530. The OSD data display apparatus 500 can further include a second storage unit 540.

The counter 510 counts the number of pixels of an OSD window (not shown). In an embodiment of the present invention, counter 510 counts the number of pixels of an OSD window (not shown) while the OSD window is activated. The OSD controller 520 outputs an OSD data request address signal REQADD for requesting OSD data OSD_D to the second storage unit 540 and a read address signal RADD for outputting OSD data OSD_D to be displayed to the first storage unit 530, in response to a counting bit CBIT. The counting bit CBIT is the initial count value of the counter 510 when an OSD window starts to be displayed.

The first storage unit 530 outputs stored OSD data OSD_D, in response to the read address signal RADD. The first storage unit 530 may use a FIFO (First In First Out) data structure.

The second storage unit 540 outputs stored OSD data OSD_D for every 2^{m} words to the first storage unit 530, in response to the OSD data request address signal REQADD, where m is a positive integer equal to or greater than 2. For example, the OSD data OSD_D transmitted by the second storage unit 540 can be 4 words, 8 words, 16 words and so on. The second storage unit 540 may comprise SRAM (Synchronous Dynamic Random Access Memory).

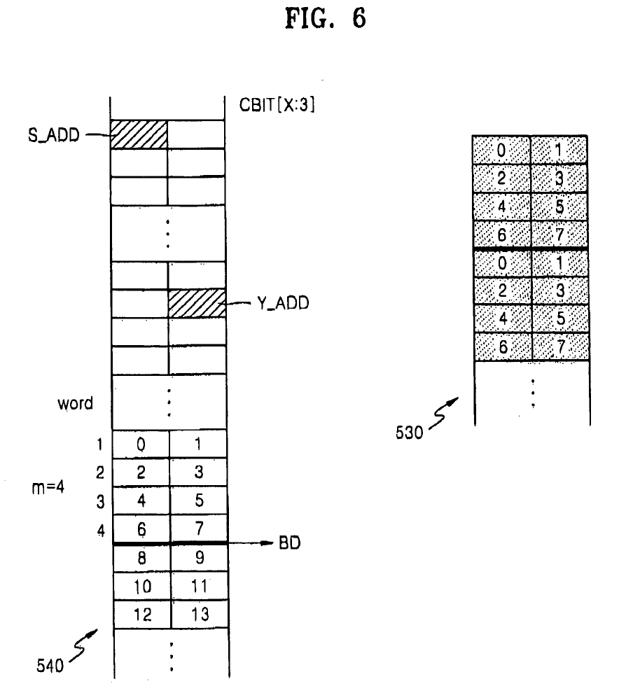

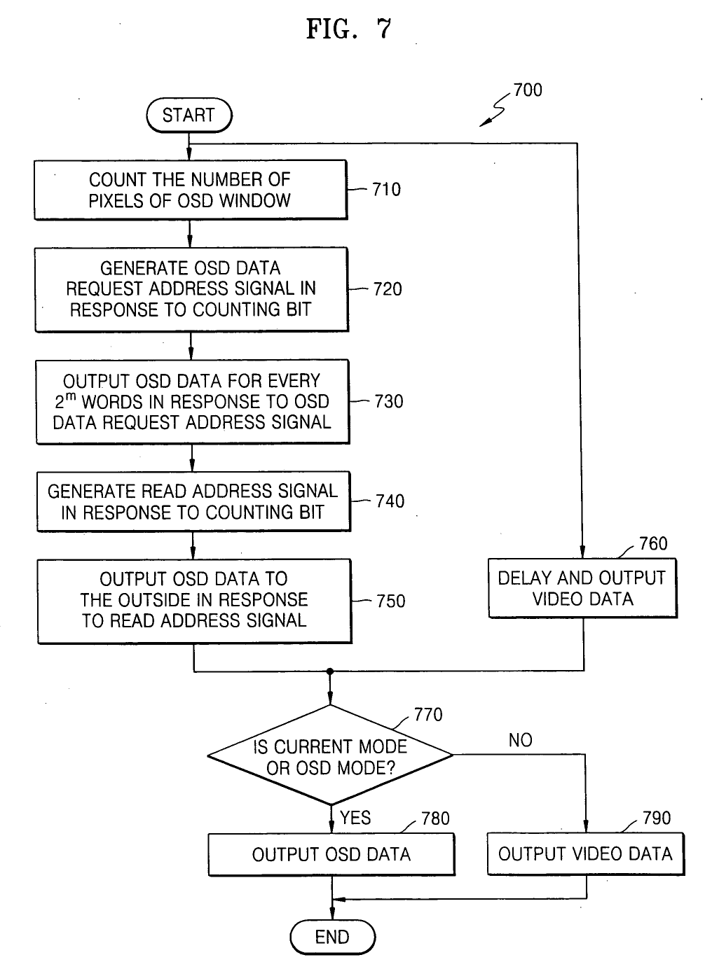

FIG. 6 shows a method—of reading OSD data from the first and second storage units 530 and 540 of the OSD data display apparatus 500 of FIG. 5. FIG. 7 is a flowchart illustrating a method of outputting OSD data according to an exemplary embodiment of the present invention. Hereinafter, a method of outputting OSD data will be described in detail with reference to FIGS. 5 through 7.

Referring to FIG. 7, while an OSD window is activated, in a step 710, the number of pixels of the OSD window is counted. This step is performed by the counter 510 of FIG. 5. It is to be understood that if a plurality of OSD windows (not shown) are activated, a plurality of corresponding counters (not shown) operate. In an embodiment of the present invention, the counter 510 of FIG. 5 operates when an OSD window with lower priority than a second overlapping OSD window (not shown) is activated.

In a step 720, an OSD data request address signal REQADD for requesting OSD data OSD_D is generated in response to a counting bit CBIT. The counting bit CBIT is the count value of the counter 510 when the OSD window starts to be displayed. The step 720 is performed using the OSD controller 520 of FIG. 5.

The counting bit CBIT represents an address of a pixel to be displayed on a screen, corresponding to one with lower priority of two overlapping windows (not shown). The OSD controller 520 divides the counting bit CBIT into an appropriate number of bits to generate the OSD data request address signal REQADD and the read address signal RADD. In a step 730, the OSD data OSD_D is output for every 2^{m} words from the second storage unit 540 in response to the OSD data request address signal REQADD.

Referring to FIG. 6, in accordance with an exemplary embodiment of the present invention, each pixel of the OSD window comprises 16 bits of OSD data OSD_D and the second storage unit 540 outputs stored OSD data OSD_D for every 4 words from the address S_ADD.

For example, when one word of the second storage unit 540 comprises 32 bits, one word can store data corresponding to two pixels, and four words can store data corresponding to 8 pixels. The numeral associated with each word of the second storage unit 540 of FIG. 6 represents an address of OSD data OSD_D of a corresponding pixel of the OSD window.

For example, during the read-out of the OSD data OSD_D, if the address Y_ADD is a binary value 0101, because 0101 in decimal is the number 5, the OSD data OSD_D stored in an address 5 of the second storage unit 540 is first displayed. In this case, in the conventional method in which the OSD data OSD_D is transmitted for every 4 words, starting from an address 5, a page crossing access occurs across the page boundary BD. However, in accordance with an exemplary embodiment of the present invention, the OSD data OSD_D is transmitted for every 4 words, starting from the first address of a unitary word group (consisting of 4 words) including the address 5, starting from an address 0.

In an exemplary embodiment of the present invention, if each pixel of the OSD window comprises 2ⁿ bits of the OSD data OSD_D, the OSD data request address signal REQADD has a logic value corresponding to a bit value obtained by replacing the lower 7-n bits of the counting bit CBIT by 0's. For example, if each pixel of the OSD window comprises 16 bits of OSD data OSD_D, n is 4 and a logic value obtained by replacing the lower 3 bits of the counting bit CBIT by 0's is the OSD data request address signal REQADD.

For example, if the counting bit CBIT is the binary value 0101, the OSD data request address signal REQADD obtained by replacing the lower 3 bits of the counting bits CBIT by 0's results in “0”. Although, in this case, a start address of OSD data OSD_D to be displayed is 5, since the OSD data request address signal REQADD becomes “0”, OSD data OSD_D is output for every 4 words, starting from an address 0. Accordingly, there need be no page crossing accesses of the second storage unit 540.

In another embodiment of the present invention, if the counting bit CBIT is a binary value 1011, although a start address of OSD data OSD_D which should be actually displayed is 11, OSD data OSD_D is output for every 4 words, starting from an address 8 being the decimal value of a binary value 1000 obtained by replacing the lower 3 bits of the counting bit 1011 by 0's.

The upper bits of the counting bit CBIT, excluding the lower 3 bits of the counting bit CBIT, can comprise 1's or 0's.

If each pixel of the OSD window has 1 bits of OSD data OSD_D, n is 3 and a value obtained by replacing the lower 4 bits of the counting bit CBIT by 0's is the OSD data request address signal REQADD. If each pixel of an OSD window has 4 bits of OSD data OSD_D, n is 2 and a value obtained by replacing the lower 5 bits of the counting bit CBIT by 0's is the OSD data request address signal REQADD.

If each pixel of the OSD window has 2 bits of OSD data OSD_D, n is 1 and a value obtained by replacing the lower 6 bits of the counting bit CBIT by 0's is the OSD data request address signal REQADD.

If each pixel of the OSD window has 1 bit of OSD data OSD_D, n is 0 and a value obtained by replacing the lower 7 bits of the counting bit CBIT by 0's is the OSD data request address signal REQADD.

In a step 740, a read address signal RADD for outputting OSD data OSD_D to be displayed is generated in response to the counting bit CBIT. The step 740 is performed by the OSD controller 520. In a step 750, stored OSD data OSD_D is output to the display apparatus in response to the read address signal RADD. The step 750 is performed by the first storage unit 530. When each pixel of the OSD window has 2ⁿ bits of OSD data, the read address signal RADD is a logic value corresponding to the lower 7-n bits of the counting bit CBIT.

If each pixel of the OSD window comprises 16 bits of OSD data OSD_D and the counting bit CBIT is 0101, n is 4 and the decimal value “5” of the binary value 101 corresponding to the lower 3 bits of the counting bit CBIT is the read address signal RADD.

Although the OSD data OSD_D received from the second storage unit 540 is data corresponding to addresses 0-7, the first storage unit 530 outputs OSD data OSD_D, starting from OSD data OSD_D corresponding to an address 5, in response to the read address signal RADD. Accordingly, OSD data OSD_D of a pixel to be displayed, corresponding to one with lower priority of two overlapping OSD windows, is output from the first storage unit 530.

If each pixel of the OSD window has 8 bits of OSD data OSD_D, n is 3 and the lower 4 bits of the counting bit CBIT are the read address signal RADD. If each pixel of the OSD window has 4 bits of OSD data OSD_D, n is 2 and the lower 5 bits of the counting bit CBIT are the read address signal RADD.

If each pixel of the OSD window has 2 bits of OSD data OSD_D, n is 1 and the lower 6 bits of the counting bit CBIT are the read address signal RADD. If each pixel of the OSD window has 1 bit of OSD data OSD_D, n is 0 and the lower 7 bits of the counting bit CBIT are the read address signal RADD.

Referring to FIG. 5, the OSD data display apparatus 500 can further include a delay unit 550 and a selector 560. The delay unit 550 delays and outputs video data VD received from an external source, in a step 760. The selector 560 selectively outputs one of the video data VD received from the delay unit 550 or the OSD data OSD_D received from the fist storage unit 530, in response to a control signal CTRL.

The steps 710 through 750 described above are performed while the step 760 of delaying and outputting the video data VD received from an external source is performed by the delay unit 550.

In a step 770, it is determined whether a current mode is a video mode or an OSD mode. Either the delayed video data VD or the OSD data OSD_D is selected and output according to the determination result (steps 780 or 790). The steps 780 and 790 are performed by the selector 560.

The selector 560 selectively outputs one of the video data VD or the OSD data OSD_D output after the steps 710 through 750, in response to the control signal CRTL, and displays the output result on a screen (not shown). The control signal CTRL, which is a signal with different logic values according to operation modes of the OSD data display apparatus 550, is used for controlling an output of the selector 560 according to the operation modes.

As described above, in an apparatus and a method for outputting an OSD of a display apparatus, according to the present invention, it is possible to reduce time required to read and transmit OSD data when OSD windows overlap.

Although the exemplary embodiments of the present invention have described in detail with reference to the accompanying drawings for the purpose of illustration, it is to be understood that the inventive processes and apparatus are not to be construed as limited thereby. It will be readily apparent to those of ordinary skill in the art that various modifications to the foregoing exemplary embodiments may be made without departing from the scope of the invention as defined by the appended claims, with equivalents of the claims to be included therein.

What is claimed is:

1. An apparatus for outputting an OSD (On-Screen Display) of a display apparatus, comprising:
a counter counting the number of pixels of an OSD window;
an OSD controller generating an OSD data request address signal for requesting OSD data and a read address signal for outputting OSD data to be displayed, in response to a counting bit; and
a first storage unit outputting stored OSD data to the display apparatus in response to the read address signal.

2. The apparatus of claim 1, wherein the counter counts the number of pixels of the OSD window while the OSD window is activated.

3. The apparatus of claim 1, wherein the counting bit is a count value of the counter when the OSD window begins to be displayed.

4. The apparatus of claim 1, wherein the OSD data request address signal is a logic value corresponding to a bit value obtained by replacing the lower 7-n bits of the counting bit by 0's, if each pixel of the OSD window has 2ⁿ bits of OSD data, wherein n is a natural number.

5. The apparatus of claim 1, wherein each pixel of the OSD window comprises 2ⁿ bits of OSD data and the read address signal is a logic value corresponding to the lower 7-n bits of the counting bit, and wherein n is a natural number.

6. The apparatus of claim 1, wherein the first storage unit uses a FIFO (First In First Out) data structure.

7. The apparatus of claim 1, further comprising:
a second storage unit outputting stored OSD data for every 2^{m} words to the first storage unit in response to the OSD data request address signal, wherein m is a natural number.

8. The apparatus of claim 7, wherein the second storage unit comprises SDRAM (Synchronous Dynamic Random Access Memory).

9. The apparatus of claim 7, wherein m is a positive integer equal to or greater than 2.

10. The apparatus of claim 1, further comprising:
a delay unit delaying and outputting video data received from an external source; and
a selector selectively outputting one of the video data received from the delay unit or the OSD data received from the first storage unit, in response to a control signal.

11. The apparatus of claim 1, wherein each pixel of the OSD window comprises 16 bits of OSD data, wherein the OSD data request address signal is a logic value corresponding to the bits of the counting bit excluding the lower 3 bits thereof, and wherein the read address signal is a logic value corresponding to the lower 3 bits of the counting bit.

12. A method of outputting an OSD of a display apparatus, comprising:
counting the number of pixels of an OSD window;
generating an OSD data request address signal for requesting the OSD data in response to a counting bit which is a count value of when the OSD window begins to be displayed;
outputting the OSD data for every 2^{m} words in response to the OSD data request address signal;
generating a read address signal for outputting OSD data to be displayed in response to the counting bit; and
outputting stored OSD data to the display apparatus in response to the read address signal.

13. The method of claim 12, wherein counting the number of pixels of the OSD window comprises counting the number of pixels of the OSD window while the OSD window is activated.

14. The method of claim 12, wherein each pixel of the OSD window comprises 2ⁿ bits of OSD data and the OSD data request address signal is a logic value corresponding to a bit value obtained by replacing the lower 7-n bits of the counting bit by 0's, and wherein n is a natural number.

15. The method of claim 12, wherein each pixel of the OSD window comprises 2ⁿ bits of OSD data and the read address signal is a logic value corresponding to the lower 7-n bits of the counting bit, wherein n is a natural number.

16. The method of claim 12, wherein m is a positive integer equal to or greater than 2.

17. The method of claim 12, further comprising:
delaying and outputting video data received from an external source;
determining whether a current mode is a video mode or an OSD mode; and
selectively outputting one of the delayed video data or the OSD data according to the determination result.

18. The method of claim 12, wherein each pixel of the OSD window comprises 16 bits of OSD data, wherein the OSD data request address signal is a logic value corresponding to the remaining bits of the counting bit excluding the lower 3 bits of the counting bit, and wherein the read address signal is a logic value corresponding to the lower 3 bits of the counting bit.

19. An apparatus for outputting an OSD window of a display apparatus, comprising:
an OSD controller, wherein the OSD controller generates an OSD data request address signal for requesting OSD data and a read address signal for outputting OSD data to be displayed, in response to a counting bit; and
a storage unit, wherein the storage unit outputs stored OSD data to the display apparatus in response to the read address signal.

20. The apparatus of claim 19, further comprising a counter, wherein the counter counts the number of pixels of the OSD window.

21. The apparatus of claim 20, wherein the counter counts the number of pixels of the OSD window while the OSD window is activated.
